(19) United States
(12) Patent Application Publication
(10) Pub. No.: US 2013/0321243 A1
(43) Pub. Date: Dec. 5, 2013

(54) Displaying Method of Integrating Multiple Electronic Devices in a Display Device and a Display Device Thereof

(71) Applicant: ASUSTeK COMPUTER INC., Taipei (TW)

(72) Inventors: Chien-Yao CHANG, Taipei (TW); Yaw-Huei CHIOU, Taipei (TW)

(73) Assignee: ASUSTeK COMPUTER INC., Taipei (TW)

(21) Appl. No.: 13/895,899

(22) Filed: May 16, 2013

(30) Foreign Application Priority Data
May 31, 2012 (TW) 101119584

(51) Int. Cl. G06F 3/14

(52) U.S. Cl. CPC G06F 3/1446
USPC 345/1.3

(57) ABSTRACT

A displaying method of integrating multiple electronic devices in a display device is disclosed. At least one of the electronic devices or the display device has compatible data. The displaying method includes steps: establishing a connection between the electronic devices and the display device, respectively; transferring the compatible data to the electronic devices or the display device without compatible data by the electronic device or the display device which includes the compatible data via the connection; generating a plurality of display areas at the display device according to the compatible data and displaying display information of the electronic devices at the display areas, respectively; and transmitting an input signal to the electronic device by the display device according to the display area corresponding to an occurring position of the input event, wherein the input signal corresponds to an input event and the electronic device corresponds to the display area.

### CROSS-REFERENCE TO RELATED APPLICATION

This application claims the priority benefit of Taiwan application serial No. 101119584, filed on May 31, 2012. The entirety of the above-mentioned patent application is hereby incorporated by reference herein and made a part of specification.

### BACKGROUND OF THE INVENTION

1. Field of the Invention

The disclosure relates to a displaying method of an electronic device and, more particularly, to a displaying method of integrating multiple electronic devices and a display device thereof.

2. Description of the Related Art

As science and technology develops, types of electronic devices, such as a smart phone, a tablet computer, a person computer (PC) or a notebook computer, are much more diverse. Since various electronic devices have different advantages and disadvantages, the user may use two or more electronic devices at the same time for functional complementation. For example, when the user goes out, he or she uses a smart phone and a tablet computer. When the user works, he or she uses a notebook computer. When the user is at home, he or she uses a personal computer (PC).

However, brands of the electronic devices are diverse. The user may have electronic devices of different brands with different operation systems. For example, the smart phone uses iOS, the tablet computer uses the Android system, and the notebook computer and the PC use the Windows system. Thus, it is difficult for the user to integrate the electronic devices with different operation systems.

### BRIEF SUMMARY OF THE INVENTION

A displaying method of integrating multiple electronic devices in a display device is provided. One of the electronic devices or the display device includes compatible data. The display method includes following steps: establishing a connection between the electronic devices and the display device, respectively; transferring the compatible data to the electronic devices or the display device which is without compatible data from the electronic device or the display device which includes the compatible data via the connection; generating a plurality of display areas at the display device according to the compatible data and displaying display information of the electronic devices at the display areas, respectively; and transmitting an input signal to the electronic device according to the display area corresponding to an occurring position of the input event by the display device, wherein the input signal corresponds to an input event and the electronic device corresponds to the display area.

A display device coupled to multiple electronic devices is also provided. The display device includes a display unit, a processing unit and an input unit. The display unit includes a plurality of display areas, wherein display information of the electronic devices is displayed at corresponding to the display areas, respectively. The processing unit is electrically connected to the display unit. The input unit is coupled to the processing unit, in which the input unit outputs an input signal according to an input event. The processing unit transmits the input signal to the electronic device corresponding to the display area according to the display area corresponding to an occurring position of the input event.

These and other features, aspects and advantages of the present disclosure will become better understood with regard to the following description, appended claims, and accompanying drawings.

### BRIEF DESCRIPTION OF THE DRAWINGS

FIG. 1 is a block diagram showing a display device in a first embodiment;

FIG. 2A is a schematic diagram showing a display device in a first embodiment;

FIG. 2B and FIG. 2C are schematic diagrams showing a display device in a second embodiment;

FIG. 3A is flow chart showing a method of integrating multiple electronic devices in a display device in a third embodiment; and

FIG. 3B is a flow chart showing a method of integrating multiple electronic devices in a display device in a fourth embodiment.

### DETAILED DESCRIPTION OF THE EMBODIMENTS

A displaying method of integrating multiple electronic devices and a display device thereof are illustrated with relating figures and the same symbol denote to the same components.

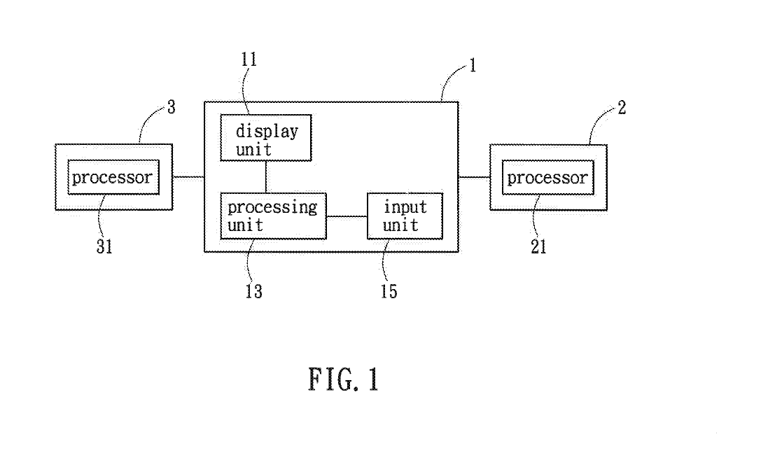

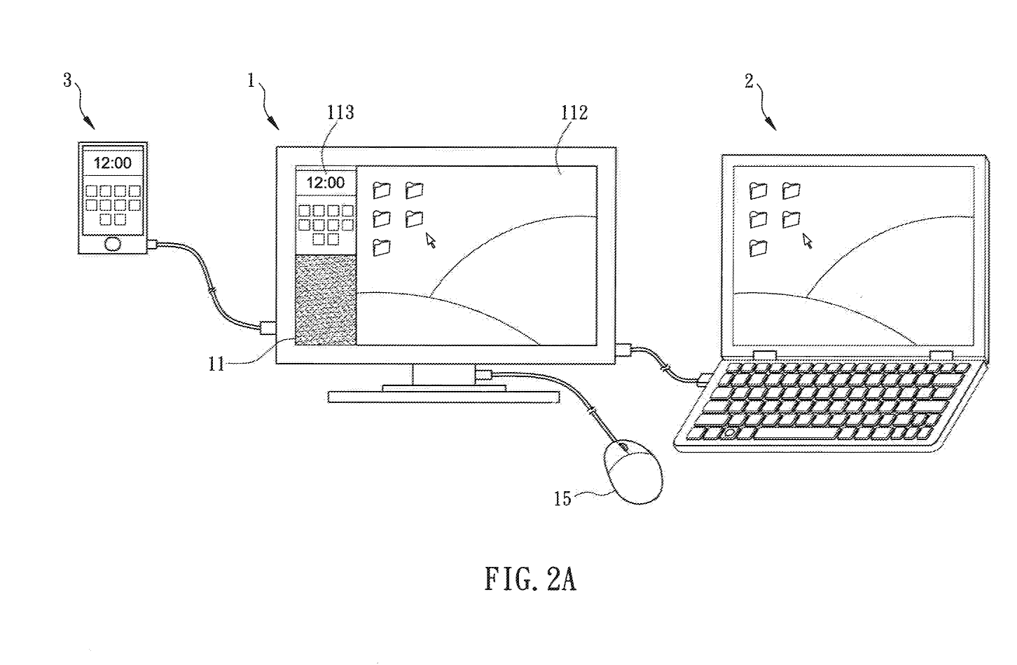

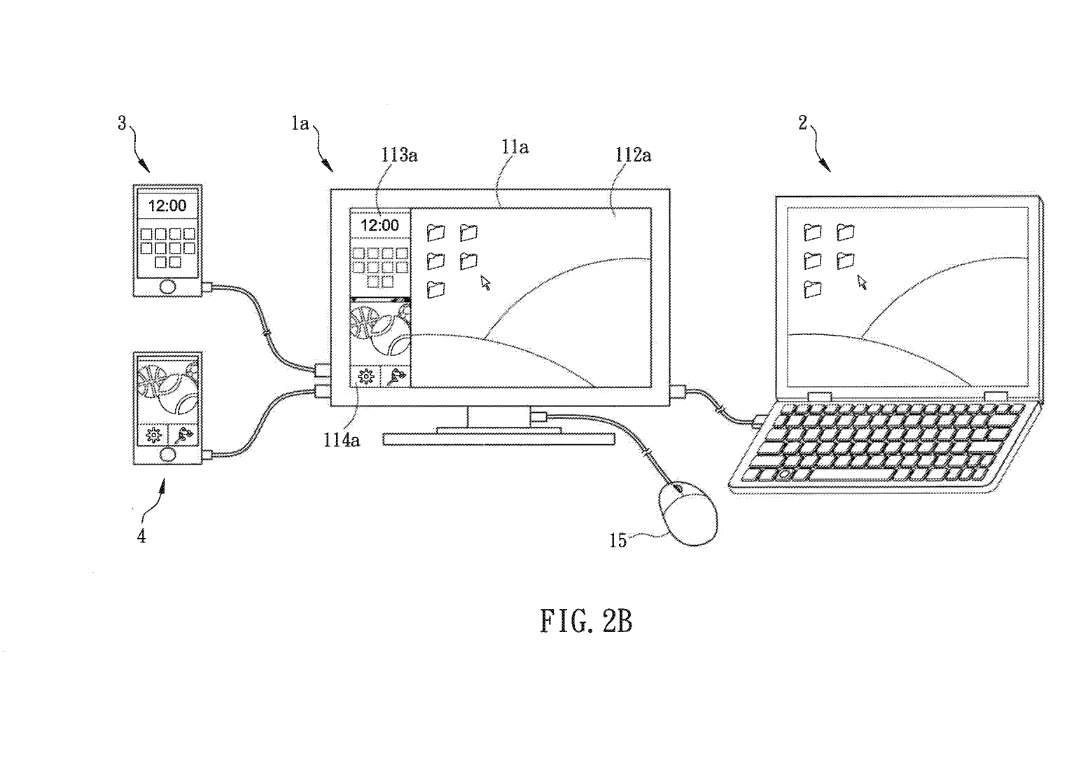

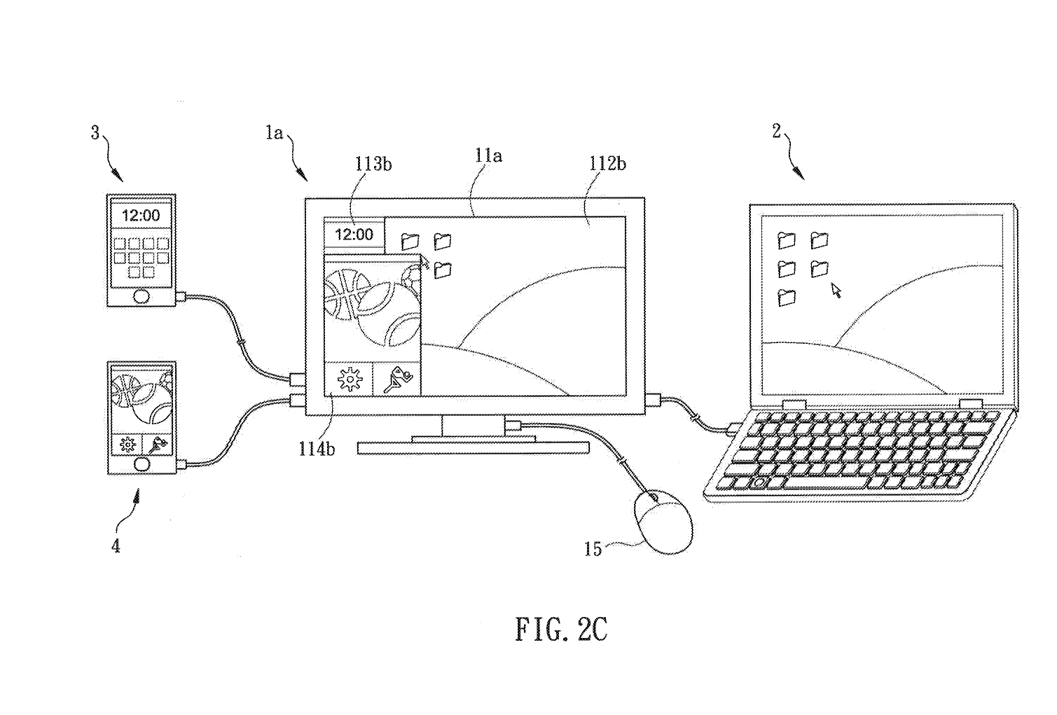

FIG. 1 is a block diagram showing a display device in a first embodiment, and FIG. 2A is a schematic diagram showing a display device in a first embodiment. The display device 1 includes a display unit 11, a processing unit 13 and an input unit 15.

As shown in FIG. 1, the display device 1 is coupled to multiple electronic devices. In this embodiment, two electronic devices 2 and 3 are taken as an example. The electronic device may be a smart phone, a tablet computer, a notebook computer or a PC, which is not limited herein. The display device 1 may be coupled to the electronic devices in a wired way or a wireless way, which is not limited herein. The wired way includes a connection via a universal serial bus (USB), a high definition multimedia interface (HDMI), a mobile high definition link (MHL), etc. The wireless way includes a connection via a wireless universal serial bus (WUSB), Bluetooth, infrared radiation (IR), near field communication (NFC), etc.

The display information of the electronic devices 2 and 3 are displayed in two display areas 112 and 113 of the display device 1, respectively. The display unit 11 may use picture by picture (PBP) or picture in picture (PIP) technology to enable the display areas to display the display information of multiple electronic devices. In practice, positions of the display areas can be changed according to practical requirements. For example, one of the display areas may be moved from the left upper corner to the right bottom corner, or its position is predetermined to be constant and cannot be changed, which is not limited herein.

The processing unit 13 is electrically connected to the display unit 11. The processing unit 13 may be a central processing unit (CPU) or a micro-controller unit (MCU), which is not limited herein.

The input unit 15 is coupled to the processing unit 13. The input unit 15 may be one or a combination of a mouse (a wired mouse or a wireless mouse), a keyboard (a wired keyboard or a wireless keyboard), a touch control pad and a motion sensor, which is not limited herein.

When the user provides an input vent by the input unit 15, the input unit 15 outputs an input signal according to the input event.

The processing unit 13 transmits the input signal to the electronic device corresponding to the display area according to the display area corresponding to an occurring position of the input event.

An event of clicking a left button of the input unit 15 (such as a mouse) to select an object in the display area 112 is taken as an example. The occurring position of the input event is at the corresponding to the display area 112, the input unit 15 generates the input signal corresponding to the event and the processing unit 13 receives the input signal, and then transmits the input signal to the electronic device 2 corresponding to the display area 112 according to the display area 112 corresponding to the occurring position of the input event. Consequently, a processor 21 of the electronic device 2 executes the motion of “selecting an object by clicking the left button” according to the input signal.

In other words, if the input event occurs at the display area 112, the input signal is processed by the processor 21. This means that the processing unit 13 only transmits the input signal to the electronic device 2 according to the occurring position of the input event.

Furthermore, when the display area corresponding to the occurring position of the input event changes to another display area, the processing unit 13 receives a conversion signal from the electronic device corresponding to the display area, and transmits the conversion signal to another electronic device corresponding to another display area.

An event which is to drag an object from the display area 112 to the display area 113 by the input unit 15 (such as a mouse) is taken as an example. The event includes three steps which are clicking the left button of the mouse to select the object, pressing the left button to drag the object and releasing the left button to release the object. The content of “clicking the left button to select” is the same as stated above, which is omitted herein.

When the occurring position of the input event of “pressing the left button to drag” changes along with the moving of a cursor, the input unit 15 generates the input signal according to the input event of “pressing the left button to drag” (the calculation is executed by the processor 21). When the cursor passes a boundary between the display area 112 and the display area 113 and arrives at the display area 113, the processor 21 outputs the conversion signal to the processing unit 13, and the processing unit 13 transmits the conversion signal to the electronic device 3. Thus, after the cursor passes the boundary between the display area 112 and the display area 113, the electronic device 3 replaces the electronic device 2 to execute the calculation.

When the user releases the left button to release the object, the input unit 15 generates the input signal according to the input event of “releasing the left button”. The processing unit 13 transmits the input signal to the electronic device 3 according to the display area 113 corresponding to the occurring position of the input event, and the processor 31 of the electronic device 3 transfers data corresponding to the object of the electronic device 2 to the electronic device 3 according to the input signal.

When the conversion signal is transmitted from the electronic device corresponding to the display area to another electronic device corresponding to another display area by the display device, the data can be transferred between the two electronic devices by the display device.

In other words, when the display area corresponding to the occurring position of the input event is change, the processing unit 13 transmits the conversion signal outputted by the electronic device 2 to the electronic device 3, and the input signal is executed by the processor 31 instead of the processor 21.

In the embodiment, at least one of the display device 1 and the electronic device 2, the electronic device 3 includes compatible data (such as an application program) in order to make the display device 1 and the electronic devices 2 and 3 compatible with each other. The display device 1, the electronic device 2 or 3 which includes the compatible data transfers the compatible data to the display device 1, the electronic device 2 or 3 which is without the compatible data. Thus, all of the display device 1, electronic devices 2 and 3 include compatible data, in which they compatible each other. The display device 1, electronic device 2 and 3 may also be compatible each other by hardware, which is not limited herein.

In one embodiment, when the electronic devices 2, 3 are coupled to the display device 1, the processing unit 13 transmits a power saving signal to the electronic devices 2 and 3, respectively, to reduce power consuming of the screens of the electronic devices 2 and 3 or shut down the screens, which can save power.

FIG. 2B and FIG. 2C are schematic diagrams showing a display device in a second embodiment. In the embodiment, the display device 1a is coupled to three electronic devices 2, 3 and 4. The display areas 112a, 113a and 114a display the display information of the electronic device 2, 3 and 4, respectively.

Moreover, the visual range of the display areas 112a, 113a and 114a of the display device 1a are adjustable. As shown in FIG. 2C, the user drags a border of the display area 114b by the input unit 15 (such as a mouse) to input a border dragging event. When the processing unit 13 detects the border dragging event of the input unit 15, it controls the display unit 11 to enlarge the visual range of the display area 114b. Any one of the display areas may be displayed in full screen or zoomed in and zoomed out non-proportionally. The visual range of the display area means the area defined by the length and the width of the display area.

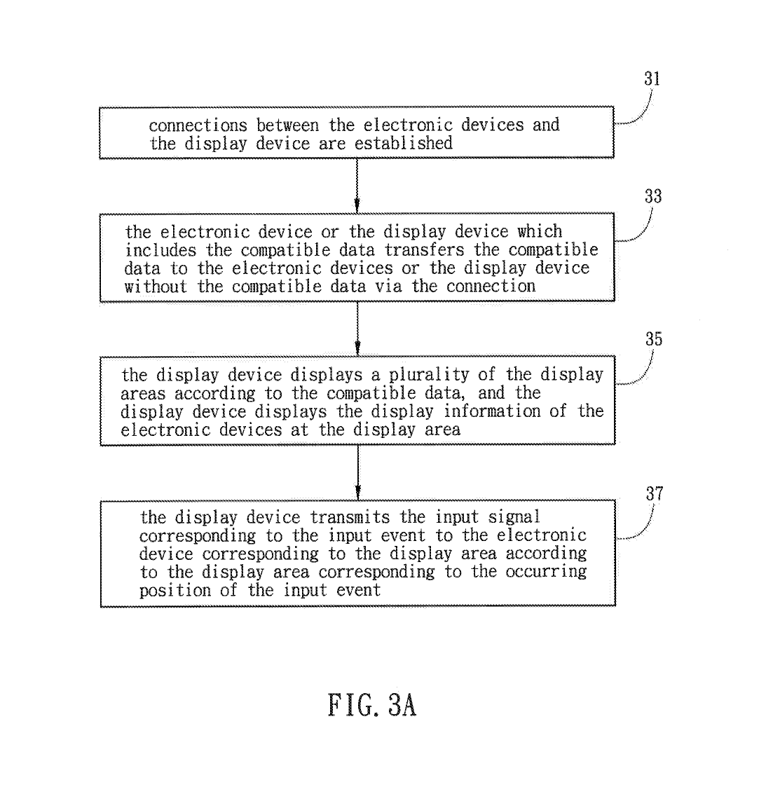

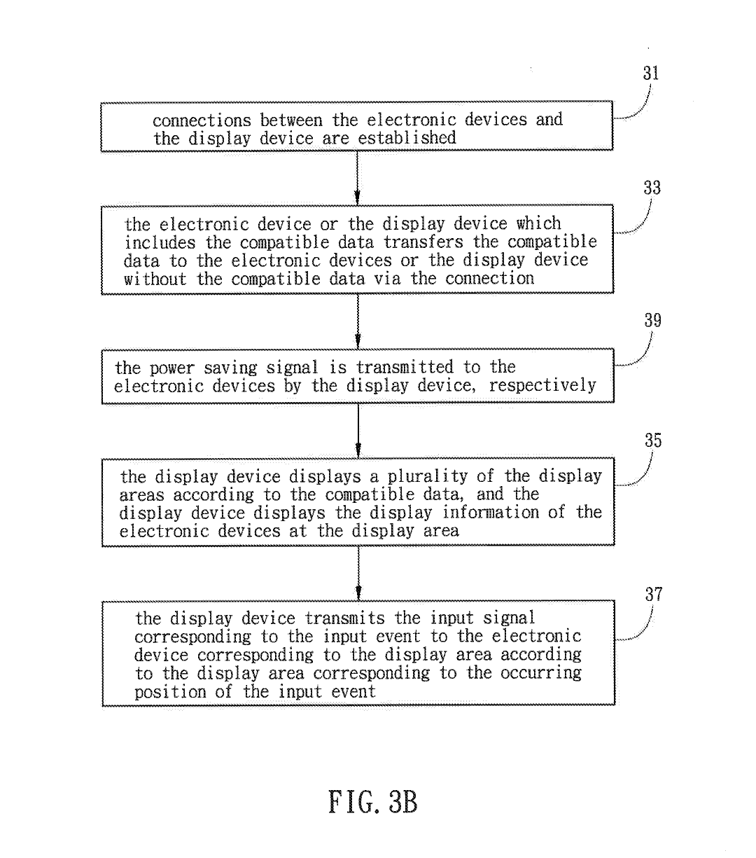

FIG. 3A is flow chart showing a method of integrating multiple electronic devices in a display device in a third embodiment, and the method is applied to the display device 1 in FIG. 1. The types of the electronic devices are illustrated above, which is omitted herein.

In step 31, connections between the electronic devices and the display device are established, respectively. The connection may be established in a wired way or a wireless way. The wired way includes a connection via a universal serial bus (USB), a high definition multimedia interface (HDMI), a mobile high definition link (MHL), etc. The wireless way includes a connection via a wireless universal serial bus (WUSB), Bluetooth, infrared radiation (IR), near field communication (NFC), etc.

In step 33, at least one of the electronic devices 2, 3 and the display device includes compatible data which may be application software which is not limited herein. One of the electronic devices or the display device which includes the compatible data transfers the compatible data to another electronic device or the display device which are without the compatible data, and thus all of the electronic devices and the display device include the compatible data. Specifically, the operation systems of the electronic devices and the display device may be different, each of the electronic devices or the display device including the compatible data transfers the compatible data to the electronic devices or the display device without the compatible data via the connection, and then the electronic devices with different operation systems can transfer data to each other by the display device, and they are compatible with each other.

In step 35, the display device displays a plurality of the display areas according to the compatible data. The display device displays the display information of the electronic devices at the display areas. Specifically, the display device 1 may use PBP or PIP technology to generate a plurality of the display areas according to the compatible data to display the display information of the electronic devices at the display areas of the display unit 11. The number of the display areas of the display unit 11 corresponds to the number of the electronic devices coupled to the display device 1.

In step 37, the display device transmits the input signal to the electronic device according to the display area corresponding to the occurring position of the input event, wherein the input signal corresponds to the input event and the electronic device corresponds to the display area. Specifically, the input unit 15 of the display device 1 outputs the input signal according to the input event, and the processing unit 13 transmits the input signal to the electronic device according to the display area corresponding to the occurring position of the input event, wherein the electronic device corresponds to the display area. The processor of the electronic device executes the input events according to the input signal.

In other words, the input signal outputted by the input unit 15 is transmitted to the corresponding electronic device by the processing unit 13. Actually, the input signal is executed by the processor of the corresponding electronic device but not is executed by the processing unit 13.

Furthermore, in step 37, when the display area corresponding to the occurring position of the input event changes to another display area, the display device receives the conversion signal from the electronic device corresponding to the display area, and then transmits the conversion signal to another electronic device corresponding to another display area.

When the conversion signal is transmitted from the electronic device corresponding to the display area to another electronic device corresponding to another display area by the display device, the data can be transferred between the two electronic devices by the display device.

For example, the user drags an object (such as a file or a document) from the display area corresponding to the electronic device 2 to the display area corresponding to the electronic device 3 by the input unit 15 (such as a mouse). The processing unit 13 of the display device 1 receives the conversion signal outputted by the processor 21 of the electronic device 2 and transmits the conversion signal to the electronic device 3. The processor 31 of the electronic device 3 receives the conversion signal and takes the execution right of calculation. Then, the processor 31 of the electronic device 3 obtains the data corresponding to the object from the electronic device 2 by the display device 1 according to the input event. In practice, the electronic device 2 may also obtain the data from the electronic device 3, which is not limited herein.

In other words, when the display area corresponding to the occurring position of the input event changes, the processing unit 13 of the display device 1 transmits the conversion signal from one of the electronic devices to another electronic device to hand over the calculation execution right. It means that the input signal is executed by the electronic devices but not is executed by the processing unit 13.

FIG. 3B is a flow chart showing a method of integrating multiple electronic devices in a display device in a fourth embodiment. The method in FIG. 3B is similar with that in FIG. 3A. The difference is that the method in FIG. 3B further includes step 39: transmitting the power saving signal to the electronic devices by the display device, respectively. Specifically, when the connection between the display device 1 and the electronic devices 2 and 3 is established and they are compatible with each other, the processing unit 13 of the display device 1 transmits the power saving signal to the electronic devices 2 and 3, respectively, to reduce power consuming of the screens of the electronic devices 2 and 3 or shut down the screens and further to save power.

In sum, the displaying method of integrating multiple electronic devices and the display device thereof can display the display information of the electronic devices coupled to the display device, and the display information is displayed at the display unit of the display device. The processing unit and the input unit enable the user to integrate various electronic devices at the display device, which improves convenience in operating.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A displaying method of integrating multiple electronic devices in a display device, wherein one of the electronic devices or the display device includes compatible data, the displaying method comprising following steps:
establishing a connection between the electronic devices and the display device, respectively;
transferring the compatible data to the electronic devices or the display device without compatible data from the electronic device or the display device which includes the compatible data via the connection;
generating a plurality of display areas at the display device according to the compatible data and displaying display information of the electronic devices at the display areas, respectively; and
transmitting an input signal to the electronic device according to the display area corresponding to an occurring position of the input event by the display device, wherein the input signal corresponds to an input event, and the electronic device corresponds to the display area.

2. The displaying method according to claim 1, wherein when the display area corresponding to the occurring position of the input event changes to another display area, the display device receives a conversion signal from the electronic device corresponding to the display area and transmits the conversion signal to another electronic device corresponding to another display area.

3. The displaying method according to claim 2, wherein object data are transferred between the electronic device corresponding to the display area and another electronic device corresponding to another display area via the display device.

4. The displaying method according to claim 1, wherein the connection is established in a wired way or a wireless way.

5. The displaying method according to claim 1, wherein the displaying method further includes the following step:
transmitting a power saving signal to the electronic devices respectively by the display device.

6. A display device coupled to multiple electronic devices, comprising:
a display unit including a plurality of display areas, wherein display information of the electronic devices are correspondingly displayed at the display areas, respectively;
a processing unit electrically connected to the display unit; and
an input unit coupled to the processing unit, wherein the input unit outputs an input signal according to an input event;
wherein the processing unit transmits the input signal to the electronic device according to the display area, wherein the electronic device corresponds to the display area and the display area corresponds to an occurring position of the input event.

7. The display device according to claim 6, wherein when the display area corresponding to the occurring position of the input event changes to another display area, the processing unit receives a conversion signal from the electronic device corresponding to the display area and transmits the conversion signal to another electronic device corresponding to another display area.

8. The display device according to claim 6, wherein the input unit is one or a combination of a mouse, a keyboard, a touch control pad and a motion sensor.

9. The display device according to claim 6, wherein a visual range of the display area is adjustable.

10. The display device according to claim 6, wherein the display device is coupled to the electronic devices in a wired way or a wireless way.
